(19) United States
(12) Patent Application Publication
(10) Pub. No.: US 2026/0021864 A1
(43) Pub. Date: Jan. 22, 2026

(54) CONTROL ASSEMBLY FOR AN ELECTRIC VEHICLE AND ELECTRIC VEHICLE HAVING SAME

(71) Applicant: BOMBARDIER RECREATIONAL PRODUCTS INC., Valcourt (CA)

(72) Inventors: Benoit SIMARD, Bromont (CA); Alexandre VERNET, Waterloo (CA)

(21) Appl. No.: 18/997,147

(22) PCT Filed: Dec. 21, 2023
(86) PCT No.: PCT/IB2023/063138

§ 371 Date: Jan. 20, 2025

Related U.S. Application Data
(60) Provisional application No. 63/435,189, filed on Dec. 23, 2022.

(51) Int. Cl. B62K 23/06; B60L 7/10; B62J 43/16; B62K 5/01; B62M 7/00

(52) U.S. Cl. CPC B62K 23/06; B60L 7/10; B62J 43/16; B62K 5/01; B62M 7/00

(57) ABSTRACT

A control assembly for an electric vehicle includes a housing, first and second actuators, a position sensor, and first and second biasing members. The first actuator is moveable between first, second and third positions, and is biased toward the first position by the first biasing member. The second actuator is moveable between fourth and fifth positions, and is biased toward the fourth position by the second biasing member. In an initial configuration, the second biasing member has a greater biasing effect than the first biasing member, such that the first and second actuators are, respectively, in the second and fourth positions. In response to the second actuator moving toward the fifth position, the first actuator moves toward the first position. The position sensor communicates to a controller that the first actuator is in a brake regeneration mode or an acceleration mode based on a position of the first actuator.

### CROSS-REFERENCE TO RELATED APPLICATION

The present application claims priority to U.S. Provisional Patent Application No. 63/435,189, filed Dec. 23, 2022 entitled “Control Assembly for an Electric Vehicle and Electric Vehicle Having Same”, which is incorporated by reference herein in its entirety.

### TECHNOLOGICAL FIELD

The present technology relates to control assemblies for electric vehicles, and electric vehicles having control assemblies.

### BACKGROUND

The use of regenerative braking systems in electric vehicles is known. A regenerative braking system enables a vehicle to convert some of its kinetic energy into electrical energy as the vehicle decelerates for charging the battery that is used to power the electric motor.

Conventional control assemblies for operating the regenerative braking system can be costly, can require additional components, and can be complex to implement alongside a mechanical braking system.

Therefore, there is a desire for a control assembly overcoming at least some of the above-mentioned disadvantages.

### SUMMARY

It is an object of the present technology to ameliorate at least some of the inconveniences present in the prior art.

According to one aspect of the present technology, there is provided a control assembly for an electric vehicle. The control assembly includes a housing, a first actuator, a position sensor, a first biasing member, a second actuator, and a second biasing member. The first actuator is moveably connected to the housing, the first actuator being moveable between a first position and a second position, and the second position and a third position, where the second position is intermediate to the first and third positions. The position sensor, which is for sensing a position of the first actuator, is communicatively connectable to a controller configured to control an electric motor of the electric vehicle. The first biasing member is provided between the first actuator and the housing, and biases the first actuator toward the first position. The second actuator is moveably connected to the housing, and is moveable between a fourth position and a fifth position. The second biasing member is provided between the second actuator and the housing, and biases the second actuator toward the fourth position. In an initial configuration, the second biasing member has a greater biasing effect than the first biasing member, such that the second actuator is in the fourth position, and the second actuator pushes on the first actuator such that the first actuator is in the second position. In response to the second actuator moving from the fourth position toward the fifth position, the first actuator moves from the second position toward the first position in response to a biasing force of the first biasing member. In response to the first actuator being between the first and second positions, the position sensor is configured to communicate to the controller that the first actuator is in a brake regeneration mode. In response to the first actuator being between the second and third positions, the position sensor is configured to communicate to the controller that the first actuator is an acceleration mode.

In some embodiments, in response to the first actuator moving from the second position toward the third position, the second actuator remains in the fourth position.

In some embodiments, the first actuator has a first abutting portion, the second actuator has a second abutting portion, and in the initial configuration, the first abutting portion abuts the second abutting portion.

In some embodiments, in response to the first actuator being in the first position, and the second actuator being in the fifth position, the first abutting portion abuts the second abutting portion.

In some embodiments, the control assembly further includes a first stopper configured to stop movement of the first actuator once the first actuator reaches the third position.

In some embodiments, the control assembly further includes a second stopper having a first side and a second side. The first side of the second stopper is configured to stop movement of the second actuator once the second actuator reaches the fourth position. The second side of the second stopper is configured to stop movement of the second actuator once the second actuator reaches the fifth position.

In some embodiments, the second actuator defines an opening, and the second stopper extends within the opening.

In some embodiments, the control assembly further includes a stopper having a first side and a second side. The first side of the stopper is configured to stop movement of the second actuator once the second actuator reaches the fourth position. The second side of the stopper is configured to stop movement of the second actuator once the second actuator reaches the fifth position.

In some embodiments, the second actuator defines an opening, and the stopper extends within the opening.

In some embodiments, the control assembly further includes a biasing assembly which includes a biasing casing, the second biasing member, and a positioning element. The biasing casing is connected to the housing. The second biasing member is received in the biasing casing. The positioning element is received in the biasing casing, and engages the second biasing member. A portion of the positioning element is configured to extend through an aperture defined in the biasing casing, and engages the second actuator. The positioning element is moveable between a projected position and a retracted position. In the projected position, the portion of the positioning element projects from the biasing casing, and the second actuator is in the fourth position. In the retracted position, the portion of the positioning element is at least partially received within the biasing casing, and the second actuator is in the fifth position.

In some embodiments, the first and second actuators are pivotally connected to the housing.

In some embodiments, the first and second actuators are pivotable about a common pivot axis.

In some embodiments, an angle between the first and third positions of the first actuator is about 45 degrees, and an angle between the fourth and fifth positions of the second actuator is about 5 degrees.

In some embodiments, in the initial configuration, the first biasing member applies a first torque to the first actuator, the second biasing member applies a second torque to the second actuator, and the second torque is greater than the first torque.

In some embodiments, the first actuator is a first lever, and the second actuator is a second lever.

In some embodiments, the first lever has a first lever arm and the second lever has a second lever arm. In response to the first lever moving toward the third position, the first lever arm moves toward the second lever arm, and in response to the second lever moving toward the fifth position, the second lever arm moves toward the first lever arm.

According to another aspect of the present technology, there is provided an electric vehicle which includes a battery pack, an electric motor, a drive assembly, a handlebar, a control assembly according to the above aspect or according to the above aspect and one or more of the above embodiments and a controller. The electric motor is electrically connected to the battery pack, and operatively connected to the drive assembly. The control assembly is connected to the handlebar. The controller is operatively connected to the electric motor, and communicatively connected to the position sensor of the control assembly. In response to the position sensor sensing that the first actuator is in the brake regeneration mode, the controller controlling the electric motor in a generator mode for decelerating the electric vehicle and for recharging the battery pack. In response to the position sensor sensing that the first actuator is in the acceleration mode, the controller controlling the electric motor in a motor mode for driving the drive assembly.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

As used herein, the term “about” in the context of a given value or range refers to a value or range that is within 20%, preferably within 10%, and more preferably within 5% of the given value or range.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a front view a straddle-seat all-terrain vehicle;

FIG. 2 is a right side elevation view of the vehicle of FIG. 1;

FIG. 3 is a top plan view of the vehicle of FIG. 1;

FIG. 4 is a perspective view taken from a top, rear, right side of a control assembly according to an embodiment of the present technology;

FIG. 5 is a cross-sectional view of part of the control assembly of FIG. 4 taken along line 5-5 of FIG. 1;

FIG. 6A is a perspective view taken from a top, rear, right side of the control assembly of FIG. 4 in an initial configuration;

FIG. 6B is a bottom plan view of the control assembly of FIG. 6A;

FIG. 7A is a perspective view taken from a top, rear, right side of the control assembly of FIG. 4 in an acceleration configuration;

FIG. 7B is a bottom plan view of the control assembly of FIG. 7A;

FIG. 8A is a perspective view taken from a top, rear, right side of the control assembly of FIG. 4 in maximum brake regeneration configuration; and

FIG. 8B is a bottom plan view of the control assembly of FIG. 8A.

### DETAILED DESCRIPTION

The present technology will be described with reference to a four-wheeled straddle-seat all-terrain vehicle 20 (hereinafter “ATV”). It is contemplated that the present technology may be used with other vehicles such as snowmobiles, scooters, motorcycles, and three-wheeled road vehicles.

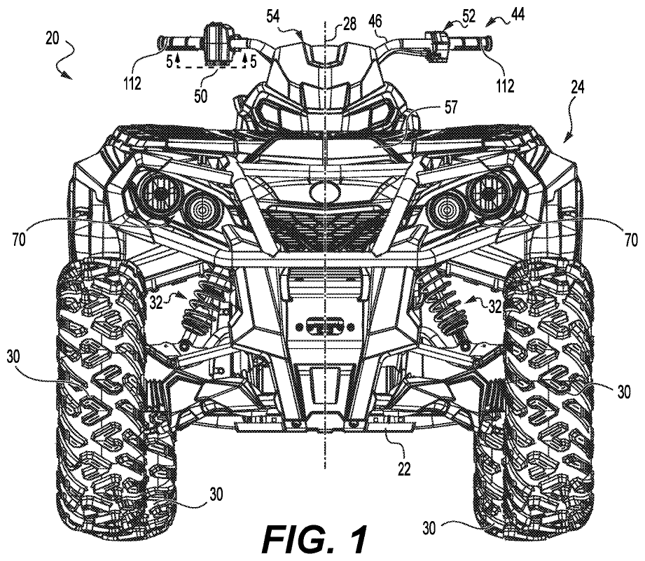

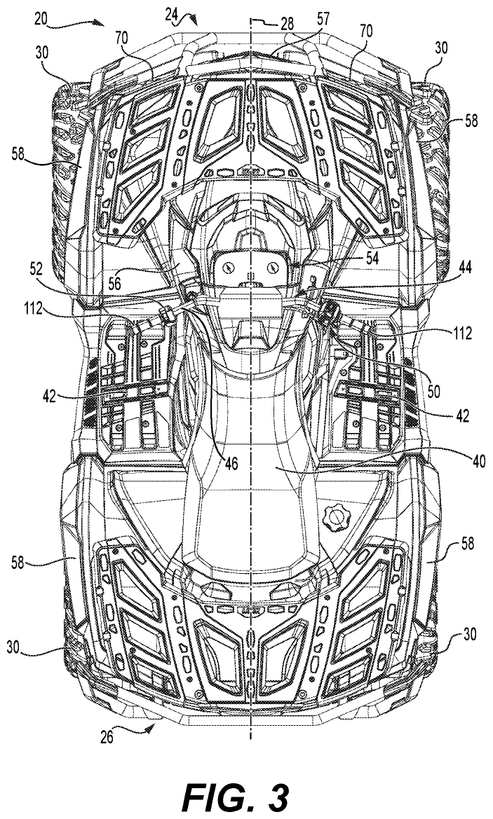

Referring to FIGS. 1 to 3, the ATV 20 has a frame 22. The frame 22 has a front end 24 and a rear end 26 defined consistently with a forward travel direction of the ATV 20. A longitudinal center plane 28 (FIGS. 1 and 3) extends vertically and longitudinally through a lateral center of the ATV 20. The ATV 20 has two front wheels 30 and two rear wheels 30. Each of the four wheels 30 is provided with low-pressure balloon tires adapted for off-road conditions and traversing rugged terrain. It is contemplated that the ATV 20 could have six wheels 30, or only three wheels 30.

The two front wheels 30 are suspended from the frame 22 by left and right front suspension assemblies 32 while the two rear wheels 30 are suspended from the frame 22 by left and right rear suspension assemblies 34.

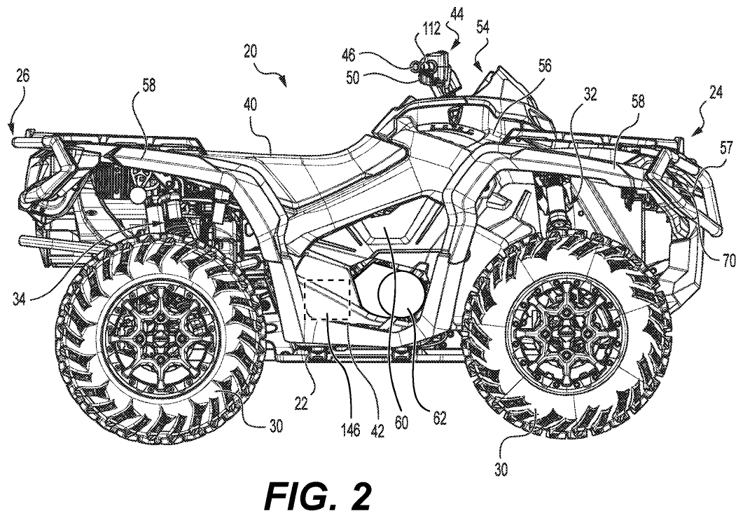

Referring back to FIGS. 1 to 3, the ATV 20 further includes a straddle seat 40 connected to the frame 22 for accommodating a driver of the ATV 20. A battery pack 60 (shown in dotted lines in FIG. 2) is supported by the frame 22, and is electrically connected to an electric motor 62 (shown schematically in FIG. 2) for powering the ATV 20. It is contemplated that the electric motor 62 could be replaced by a hybrid propulsion unit (i.e., an internal combustion engine and an electric motor). The battery pack 60 and the electric motor 62 are disposed under the straddle seat 40. The wheels 30 are operatively connected to the electric motor 62. It is contemplated that one electric motor 62 could be provided to drive the front wheels 30 and that another electric motor 62 could be provided to drive the rear wheels 30. It is contemplated that the electric motor 62 could be connected to other drive assemblies. For instance, in some embodiments, the electric motor 62 could be operatively connected to track systems.

Footrests 42 are laterally provided on either side of the straddle seat 40 and are disposed vertically lower than the straddle seat 40 to support the driver's feet. The footrests 42 are connected to the frame 22.

A steering assembly 44 is rotationally connected the frame 22 to enable a driver to steer the ATV 20. The steering assembly 44 includes a handlebar 46 connected to a steering column assembly (not shown) for actuating steering linkages (not shown) operatively connected to left and right front wheels 30. Handle grips 112 are disposed on the ends of the handlebar 46. Other steering input devices, such as a steering wheel, could be used in other vehicles.

A control assembly 50 is mounted to a right side of the handlebar 46. The control assembly 50, which can be used to accelerate and/or brake the vehicle, will be described in greater detail below.

A switch control assembly 52 is mounted to a left side of the handlebar 46. The switch control assembly 52 includes a speed limiter switch, a run and stop switch, a light switch. It is contemplated that in other embodiments, the switch control assembly 52 could include more or fewer switches.

A display cluster 54, including a number of gauges and buttons, is disposed forwardly of the steering assembly 44.

The ATV 20 also includes fairings 56 extending over the frame 22 of the ATV 20, including a front fascia 57. A fender 58 is disposed over each wheel 30 to protect the driver and/or passenger from dirt, water and other debris being projected by the rotating wheels 30. The fenders 58 also define a portion of the wheel well in which each one of the wheels 30 rotates and, in the case of the front wheels 30, steers.

The ATV 20 also includes left and right headlights 70 that are mounted to the front fascia 57. It is contemplated that in some vehicles there could be only one headlight 70, or that there could be more than two headlights 70.

The ATV 20 further includes other components such as brakes, a radiator, and the like. As it is believed that these components would be readily recognized by one of ordinary skill in the art, further explanation and description of these components will not be provided herein.

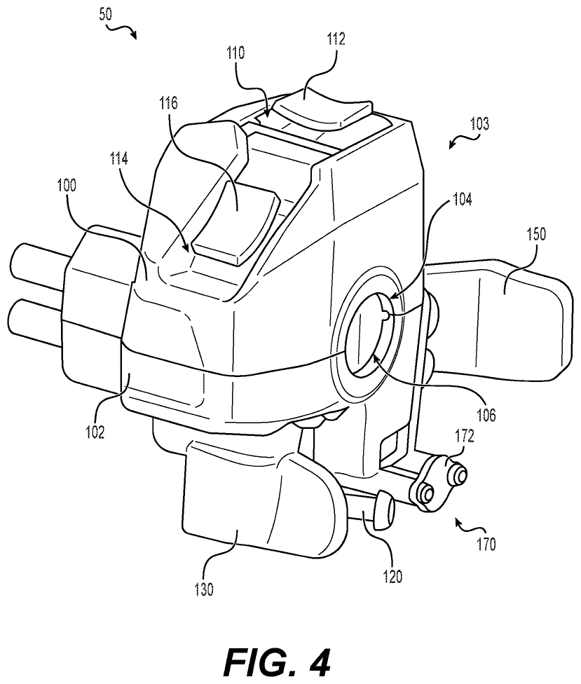

Referring to FIG. 4, the control assembly 50 will now be described in greater detail. As mentioned above, the control assembly 50 is mounted to the right side of the handlebar 46, next to the right handle grip 112. The control assembly 50 includes a top housing portion 100, and a bottom housing portion 102. The top and bottom housing portions 100, when connected, form a housing 103. The top housing portion 100 defines a recess 104 on each lateral side thereof. Similarly, the bottom housing portion 102 also defines a recess 106 on each lateral side thereof. When the top and bottom housing portions 100, 102 are connected to one another, the recesses 104, 106 define a circular opening on each lateral side of the housing 103, inside which the handlebar 46 is received. It is contemplated that in alternative embodiments, the housing 103 could be one integral component. In other embodiments, the housing 103 could be made of more than two portions.

The top housing portion 100 defines on its top surface a driving mode switch aperture 110, in which a driving mode switch 112 is installed. The driving mode switch 112 enables an operator to select one of an eco mode, a work mode, a normal mode and a sport mode. The selected mode has an impact on the ride performance of the ATV 20 (e.g., enhanced battery-life, enhanced acceleration).

The top housing portion 100 also has an inclined surface, upon which a traction mode switch aperture 114 is defined. A traction mode switch 116 is installed in the traction mode switch aperture 114. The traction mode switch 116 enables an operator to select between 2×4 or 4×4 operation of the ATV 20.

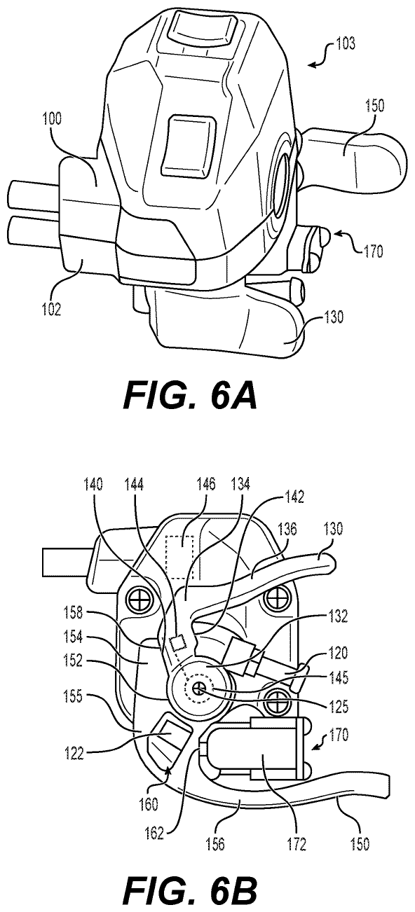

The bottom housing portion 102 has a stopper 120 and a stopper 122 (both are shown in FIGS. 6B, 7B and 8B). The stoppers 120, 122, which extend below the bottom housing portion 102, will be described in greater detail below.

Referring to FIGS. 4 and 6A, 6B, 7A, 7B, 8A and 8B, the control assembly 50 also includes an acceleration actuator 130 and a regenerative braking actuator 150, both of which are moveably connected to the housing 103.

A description of the acceleration actuator 130 will first be provided. In the illustrated embodiment, the acceleration actuator 130 is pivotably connected to the bottom housing portion 102 about a pivot axis 125. It is contemplated that in other embodiments, the acceleration actuator 130 could be connected to the housing 103 differently. For example, in some embodiments, the acceleration actuator 130 could be connected so as to be linearly moveable relative to the housing 103.

The acceleration actuator 130 is an acceleration lever 130. It is understood that in other embodiments, the acceleration actuator 130 could be another type of actuator such as a button. The acceleration actuator 130 will henceforth be referred to as an acceleration lever 130. In the non-limiting illustrated embodiment, the acceleration lever 130 includes a connecting portion 132, an abutting portion 134 which extends radially from the connecting portion 132, and a lever arm 136 which extends generally perpendicularly from the abutting portion 134.

The connecting portion 132, which is generally cylindrical, is pivotably connected to the bottom housing portion 102 about the pivot axis 125.

The abutting portion 134 includes an abutting surface 140 and another abutting surface 142 opposite to the abutting surface 140. As will be described in greater detail below, the abutting surface 140 is configured to abut the regenerative braking actuator 150, whereas the abutting surface 142 is configured to abut the stopper 120.

The lever arm 136 is configured to extend along a rear of the housing 103, in a direction generally parallel to the handlebar 46. The lever arm 136 is moveable toward the front of the housing 103 to accelerate the ATV 20. As a result, due to a position and orientation of movement of the lever arm 136, the acceleration lever 130 can easily be moved by a thumb of a driver of the ATV 20.

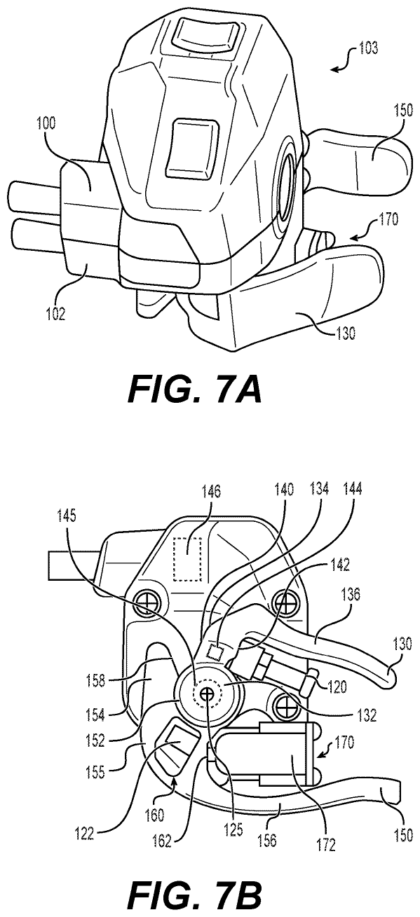

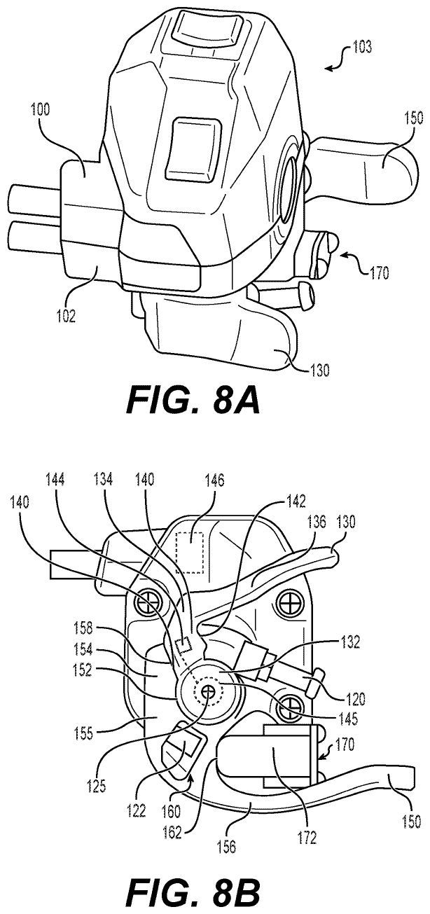

The acceleration lever 130 is moveable between a neutral position (FIGS. 6A and 6B), a maximum acceleration position (FIGS. 7A and 7B), and a maximum brake regeneration position (FIGS. 8A and 8B). For convenience, the maximum acceleration position will henceforth be referred to as the acceleration position, and the maximum brake regeneration position will be referred to as the regeneration position. As shown in the Figures, the neutral position is intermediate to the acceleration position and the regeneration position. Since the acceleration lever 130 is pivotally connected to the housing 103, it is understood that the various positions are angularly spaced from one another. In some instances, an angle between the neutral position and the acceleration position is about 40 degrees, and an angle between the neutral position and the regeneration position is about 5 degrees. Thus, an angle between the acceleration position and the regeneration position is about 45 degrees. It is understood that in alternative embodiments of the present technology, the angle between the various positions could vary.

The acceleration lever 130 is biased toward the regeneration position by an acceleration biasing member 145 (shown in dotted lines in FIGS. 6B, 7B and 8B), which is provided between the acceleration lever 130 and the housing 103. The acceleration biasing member 145 is a torsional spring 145. It is contemplated that the acceleration biasing member 145 could be another type of biasing member such as a polymeric member or a linear spring. It is to be noted that in the neutral position, the acceleration biasing member 145 is resiliently deformed, and as such is biased to move the acceleration lever 130 toward the regeneration position.

The position of the acceleration lever 130 is sensed by a position sensor 144 (shown schematically). In the present embodiment, the position sensor 144 is an angular position sensor. In other embodiments, the position sensor 144 could be a linear position sensor. The position sensor 144 is communicatively connected to a controller 146 (shown schematically in FIG. 2). The controller 146, which is disposed proximate to the battery 60 and the engine 62, is operatively connected to the electric motor 62. As will be described in greater detail below, when the acceleration lever 130 is in an acceleration mode (between neutral and acceleration position), the position sensor 144 and the controller 146 can cause the electric motor 62 to be controlled in a motor mode, and when the acceleration lever is in a regenerative braking mode (between neutral and regeneration position) the position sensor 144 and the controller 146 can cause the electric motor 62 to be controlled in a generator mode. In some instances, the controller 146 could be configured to alter the mode of the electric motor 62 differently than via the position of the acceleration lever 130.

Still referring to FIGS. 4 and 6A, 6B, 7A, 7B, 8A and 8B, a description of the regenerative braking actuator 150 will now be provided.

In the illustrated embodiment, the regenerative braking actuator 150 is pivotably connected to the bottom housing portion 103 about the pivot axis 125. Thus, the regenerative braking actuator 150 pivots about the same axis as the acceleration lever 130. As will be described in greater detail below, the regenerative braking actuator 150 is connected to the housing 103 by the acceleration lever 130. It is contemplated that in some embodiments, the regenerative braking actuator 150 could be connected to the housing 103 differently. For instance, in some embodiments, the regenerative braking actuator 150 could be pivotably connected to the housing 103 about an axis spaced from the pivot axis 125 independently of the acceleration lever 130. In other embodiments the regenerative braking actuator 150 could be linearly moveable relative to the housing 103.

The regenerative braking actuator 150 is a regenerative braking lever 150. It is understood that in some embodiments, the regenerative braking actuator 150 could be another type of actuator such as a button. Henceforth, the regenerative braking actuator 150 will be referred to as a regenerative lever 150. In the non-limiting illustrated embodiment, the regenerative lever 150 includes a connecting portion 152, an abutting portion 154 extending radially and rearwardly from the connecting portion 152, an intermediate portion 155 extending radially from the connecting portion 152, and a lever arm 156 extending from the intermediate portion 155.

The connecting portion 152 defines an arcuate recess that is sized to receive the connecting portion 132 of the acceleration lever therein. As such, the connecting portions 132, 152 form a hinged joint. The relative movement between the connecting portions 132, 152 about the pivot axis 125 is enabled by the low friction therebetween. In other instances, there may be a bearing or some lubricant between the connecting portions 132, 152. As mentioned hereabove, in some instances, the connecting portions 132, 152 could be spaced from one another.

The abutting portion 154, which is shaped to be complementary to the abutting portion 134, has an abutting surface 158. As will be described below, the abutting surface 158 is configured to abut with the abutting surface 140 of the acceleration lever 130.

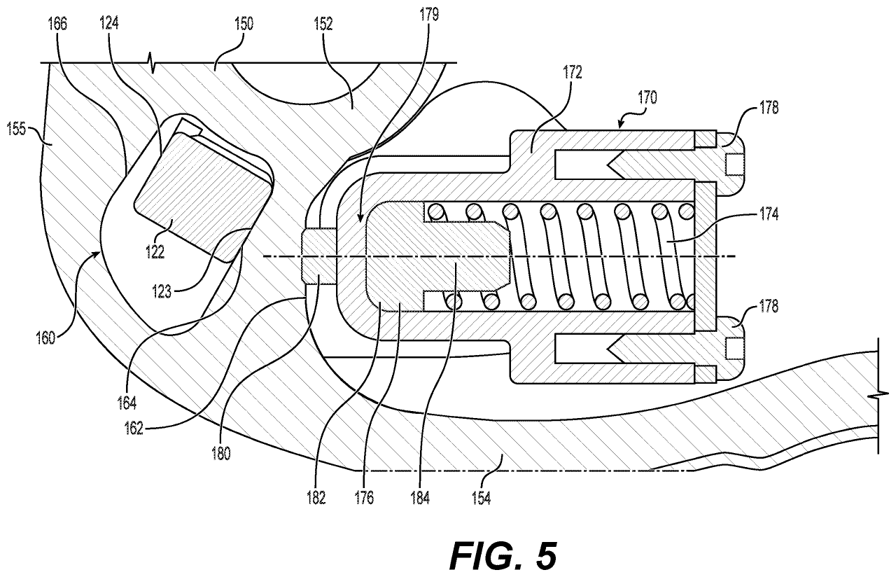

The intermediate portion 155 extends between the abutting portion 154 and the lever arm 156. The intermediate portion 155 is shaped such that the abutting portion 154 is generally perpendicular to the lever arm 156. The intermediate portion 155 defines an opening 160 that receives the stopper 122. More specifically, the opening 160 is at least partially arcuate, and is sized so that the stopper 122 can move within the opening 160 relative to the regenerative lever 150. As will be described below, the stopper 122 can abut with one of abutting surfaces 164, 166. The abutting surfaces 164, 166 partially define the opening 160. It is contemplated that in some embodiments, the opening 160 could be a recess. Alternatively, the intermediate portion 155 could have protrusions configured to engage with the stopper 122. Additionally, the intermediate portion 155 also has an engaging surface 162 that is engaged with a biasing assembly 170 (shown in FIG. 5). The biasing assembly 170 will be described below.

The lever arm 156 is configured to extend along a front of the housing 103, in a direction generally parallel to the handlebar 46. The lever arm 156 is moveable toward the rear of the housing 103 (i.e., toward the acceleration lever 130) to cause a regenerative braking of the ATV 20. As a result, the lever arm 156 can easily be moved by one or more fingers of a driver of the ATV 20 (e.g., by index and/or middle fingers).

The regenerative lever 150 is moveable between a neutral position (FIGS. 6A, 6B, 7A, 7B) and a maximum brake regeneration position (FIGS. 8A and 8B). For convenience, and to differentiate from the positions of the acceleration lever 130, the neutral position will be referred to as the initial position, and the maximum brake regeneration position will be referred to as the final position. Similarly to the acceleration lever 130, since the regenerative lever 130 is pivotally connected to the housing 103, it is understood that the neutral and final positions are angularly spaced from one another. In some instances, an angle between the initial position and the final position is about five degrees. That said, it is understood that the in alternative embodiments of the present technology, the angle between the neutral and maximum positions could vary.

As best seen in FIG. 5, when the regenerative lever 150 is in the initial position, the abutting surface 164 abuts a side 123 of the stopper 122 and when the regenerative lever 150 is in the final position, the abutting surface 166 abuts a side 124 of the stopper 122.

The regenerative lever 150 is biased toward the initial position by the biasing assembly 170, which will now be described in greater detail with reference to FIG. 5. The biasing assembly 170 includes a biasing casing 172, a regeneration biasing member 174 and a positioning member 176.

The biasing casing 172 is connected to the housing 103. More precisely, the biasing casing 172 is connected to the lower housing portion 102 by two fasteners 178. It is contemplated that the biasing casing 172 could be connected to the housing 103 differently. The biasing casing 172, which has the regeneration biasing member 174 and the positioning member 176 received therein, defines an aperture 179 that is configured to receive part of the positioning member 176 therethrough.

The positioning member 176, which is moveable relative to the biasing casing 172 between a projected position (FIGS. 5, 6B and 7B) and a retracted position (FIG. 8B), has an engaging portion 180, a stopping portion 182 and a tail portion 184.

The engaging portion 180 is sized to be receivable through the aperture 179, and as will be described in greater detail below, engages the engaging surface 162 of the acceleration lever 150. In the present embodiment, the engaging portion 180 is in constant engagement with the engaging surface 162. The stopping portion 182, which extends from the engaging portion 180, is radially larger than the engaging portion 180. More specifically, the stopping portion 182 is sized to not be receivable through the aperture 179. As a result, the stopping portion 182 can limit the movement of the positioning member 176 relative to the biasing casing 172. The tail portion 184 extends from the stopping portion 182, and is radially smaller than the stopping portion 182. The tail portion 184 can assist in providing a stable connection between the positioning member 176 and the regeneration biasing member 174. The tail portion 184 could be omitted in some embodiments.

The regeneration biasing member 174 is a spring, with one end engaging a wall of the casing 170, and another end engaging the stopping portion 182. The tail portion 184 is received within the spring. It is contemplated that the regeneration biasing member 174 could be another type of biasing member, such as, for example, an elastomeric member.

The regeneration biasing member 174 biases the positioning member 176 toward the projected position. As a result, since the engaging portion 180 engages the engaging surface 162, the regeneration biasing member 174 also biases the regenerative lever 150. More specifically, as the biasing assembly 170 causes the regenerative lever 150 to pivot until the abutting surface 164 abuts the stopper 120, when the positioning member 176 is in the projected position, the regenerative lever 150 is in the initial position.

On the other hand, when a force is applied to the regenerative lever 150 causing it to move from the initial position toward the final position, the positioning member 176 moves toward the retracted position due to the engagement between the engaging portion 180 and the engaging surface 162. When the regenerative lever 150 reaches the final position, the positioning member 176 is in the retracted position.

With reference to FIGS. 6A, 6B, 7A, 7B, 8A and 8B, the operation of the control assembly 50 will now be described.

In FIGS. 6A and 6B, the control assembly 50 is in an initial configuration. In the initial configuration, the acceleration lever 130 is in the neutral position, and the regenerative lever 150 is in the initial position such that the abutting surface 140 of the acceleration lever 130 abuts the abutting surface 158 of the regenerative lever 150. The acceleration lever 130 is in the neutral position despite being biased toward the regeneration position, because the biasing effect of the regeneration biasing member 174 is greater than the biasing effect of the acceleration biasing member 145. In the illustrated embodiment, being that the acceleration and regenerative levers 130, 150 are pivotable about the pivot axis 125, in the initial configuration, a torque applied by the regeneration biasing member 174 is greater than a torque applied by the acceleration biasing member 145. It is to be noted that the regenerative lever 150 remains in the neutral position despite the biasing forces of the regeneration biasing member 174 because of the stopper 122.

In this configuration, the position sensor 144 senses that the acceleration lever 130 is in the neutral position and communicates this to the controller 146. In this configuration, the controller 146 does not control the electric motor 62 to be in either one of a regeneration mode or a motor mode.

In FIGS. 7A and 7B, the control assembly 50 is in an acceleration configuration. In this configuration, a driver of the ATV 20 has moved the acceleration lever 130 so that it is in the acceleration position. It is to be noted that in order to do so, the driver has applied sufficient force to overcome the biasing effect of the acceleration biasing member 145. To reach this configuration, the driver has moved the acceleration lever 130 until the abutting surface 142 abuts the stopper 120. It is to be noted, that in response to the acceleration lever 130 moving from the neutral position to the acceleration position, the regenerative lever 150 remains in the initial position, because of the biasing effect by the biasing assembly 170, and the regenerative lever 150 abutting the stopper 122.

In this configuration, the position sensor 144 senses that the acceleration lever 130 is in the acceleration position, and thus that the acceleration lever 130 is in the acceleration mode. This is communicated to the controller 146. In response, the controller 146 controls the electric motor 62 to be in a motor mode for driving the wheels 30 that are operatively connected to the electric motor 62.

It is to be noted that in some instances, the driver of the ATV could move the acceleration lever 130 to a position intermediate to the neutral position and the acceleration position. In such a position, the position sensor 144 would also sense that the acceleration lever 130 is in the acceleration mode, and the controller 146 would also control the electric motor 62 to be in the motor mode. However, the torque generated by the electric motor 62 would be less than when the acceleration lever 130 is in the acceleration position.

In FIGS. 8A and 8B, the control assembly 50 is in a brake regeneration configuration. In this configuration, a driver of the ATV 20 has moved the regenerative lever 150 so that it is in the final position. It is to be noted that in order to do so, the driver has applied sufficient force to overcome the biasing effect of the regeneration biasing member 176. To reach this configuration, the driver has moved the regenerative lever 150 until the abutting surface 166 abuts the side 124 of the stopper 122.

In response to the regenerative lever 150 moving toward the final position, and the driver of the ATV 20 not applying a force on the acceleration lever 130, the acceleration lever 130 moves toward the regeneration position. In the present embodiment, when the regenerative lever 150 reaches the final position, the acceleration lever 130 reaches the regeneration position. The acceleration lever 130 moves to the regeneration position, because the regenerative lever 150 no longer pushes on the acceleration lever 130, such that the acceleration biasing member 120 causes the acceleration lever 130 toward the regeneration position.

In this configuration, the position sensor 144 senses that the acceleration lever 130 is in the regeneration position, and thus that the acceleration lever 130 is in the brake regeneration mode. This is communicated to the controller 146. In response, the controller 146 controls the electric motor 62 to be in a generator mode. In the generator mode, if the ATV 20 is moving, the electric motor 62 decelerates the ATV 20, and recharges the battery pack 60. In some implementations of the present technology, being that the brake regeneration mode is independent of the braking system of the ATV 20, the life of the braking system can be extended.

It is to be noted that in some instances, the driver of the ATV 20 could move the regenerative lever 150 to a position intermediate to the initial position and the maximum position. In response, the acceleration lever 130 would move to a position intermediate to the neutral position and the regeneration position. In such a position, the position sensor 144 would also sense that acceleration lever 130 is in the regeneration mode, and the controller 146 would also control the electric motor 62 to be in the generator mode. However, the deceleration would be less than when the acceleration lever 130 is in the regeneration position. In some embodiments, the position of the acceleration lever 130 between the neutral and regeneration positions is linearly proportional to the deceleration provided by the ATV 20.

One will note that according to an embodiment of the present technology, if the driver of the ATV 20 causes the acceleration lever 130 and the regenerative lever 150 to both move, being that the position sensor 144 senses the position of the acceleration lever 130, the controller 146 will control the electric motor 62 to be in the motor mode.

One will appreciate that according to an aspect of the present technology, the acceleration and regenerative deceleration of the ATV 20 can be controlled by a single sensor.

In some instances, the controller 146 may override the actuation of the acceleration lever 130 or the regenerative lever 150 by the driver in response to some predetermined limitations and/or requirements. For example, an anti-lock system may cause the controller 146 to prevent the electric motor 62 from going in the generator mode when a sensor senses that negative torque causes slipping.

Additionally, while it is described above that the acceleration lever 130 is easily operable by the thumb, and that the regenerative lever 150 is easily operable by the index and/or middle finger, it is contemplated that an orientation of the housing 103 may be moved about the handrail 46 to which the housing 103 is connected. The orientation of the housing 130 may be moved for a variety of reasons, such as for example, improved ergonomics. In some instances, this movement can be enabled by circular openings defined by the recesses 104, 106. As a result of the movement of the housing 103, the acceleration lever 130 and the regenerative lever 150 may be operable differently. For example, it may be easier to operate the regenerative lever 150 with the thumb, and to operate the acceleration lever 130 with the index. The controller 146 can also be selectively updated (e.g., via an input) to vary a reading of the position sensor 144 such that the acceleration lever 130 becomes associated with the regenerative braking, and the regenerating lever 150 becomes associated with the acceleration. This modification can be particularly useful when changing an orientation of the housing 103.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A control assembly for an electric vehicle, the control assembly comprising:
a housing;
a first actuator moveably connected to the housing, the first actuator being moveable between:
a first position and a second position, and
the second position and a third position, the second position being intermediate to the first and third positions;
a position sensor for sensing a position of the first actuator, the position sensor being communicatively connectable to a controller configured to control an electric motor of the electric vehicle;
a first biasing member provided between the first actuator and the housing, the first biasing member biasing the first actuator toward the first position;
a second actuator moveably connected to the housing, the second actuator being moveable between a fourth position and a fifth position; and
a second biasing member provided between the second actuator and the housing, the second biasing member biasing the second actuator toward the fourth position,
in an initial configuration, the second biasing member has a greater biasing effect than the first biasing member, such that
the second actuator is in the fourth position, and
the second actuator pushes on the first actuator such that the first actuator is in the second position,
in response to the second actuator moving from the fourth position toward the fifth position, the first actuator moves from the second position toward the first position in response to a biasing force of the first biasing member,
in response to the first actuator being between the first and second positions, the position sensor is configured to communicate to the controller that the first actuator is in a brake regeneration mode, and
in response to the first actuator being between the second and third positions, the position sensor is configured to communicate to the controller that the first actuator is an acceleration mode.

2. The control assembly of claim 1, wherein in response to the first actuator moving from the second position toward the third position, the second actuator remains in the fourth position.

3. The control assembly of claim 1, wherein the first actuator has a first abutting portion, the second actuator has a second abutting portion, and in the initial configuration, the first abutting portion abuts the second abutting portion.

4. The control assembly of claim 3, wherein in response to the first actuator being in the first position, and the second actuator being in the fifth position, the first abutting portion abuts the second abutting portion.

5. The control assembly of claim 1, further comprising a first stopper configured to stop movement of the first actuator once the first actuator reaches the third position.

6. The control assembly of claim 5, further comprising a second stopper having a first side and a second side, the first side of the second stopper being configured to stop movement of the second actuator once the second actuator reaches the fourth position; and the second side of the second stopper being configured to stop movement of the second actuator once the second actuator reaches the fifth position.

7. The control assembly of claim 6, wherein the second actuator defines an opening, and the second stopper extends within the opening.

8. The control assembly of claim 1, further comprising a stopper having a first side and a second side, the first side of the stopper being configured to stop movement of the second actuator once the second actuator reaches the fourth position; and the second side of the stopper being configured to stop movement of the second actuator once the second actuator reaches the fifth position.

9. The control assembly of claim 8, wherein the second actuator defines an opening, and the stopper extends within the opening.

10. The control assembly of claim 1, further comprising a biasing assembly comprising:
a biasing casing connected to the housing;
the second biasing member received in the biasing casing;
a positioning element received in the biasing casing, and engaging the second biasing member, a portion of the positioning element being configured to extend through an aperture defined in the biasing casing, the portion of the positioning element engages the second actuator, the positioning element being moveable between:
a projected position, in which the portion of the positioning element projects from the biasing casing, and the second actuator is in the fourth position; and
a retracted position, in which the portion of the positioning element is at least partially received within the biasing casing, and the second actuator is in the fifth position.

11. The control assembly of claim 1, wherein the first and second actuators are pivotally connected to the housing.

12. The control assembly of claim 11, wherein the first and second actuators are pivotable about a common pivot axis.

13. The control assembly of claim 11, wherein:
an angle between the first and third positions of the first actuator is about 45 degrees; and
an angle between the fourth and fifth positions of the second actuator is about 5 degrees.

14. The control assembly of claim 11, wherein in the initial configuration:
the first biasing member applies a first torque to the first actuator;
the second biasing member applies a second torque to the second actuator; and
the second torque is greater than the first torque.

15. The control assembly of claim 1, wherein the first actuator is a first lever, and the second actuator is a second lever.

16. The control assembly of claim 15, wherein:
the first lever has a first lever arm,
the second lever has a second lever arm,
in response to the first lever moving toward the third position, the first lever arm moves toward the second lever arm; and
in response to the second lever moving toward the fifth position, the second lever arm moves toward the first lever arm.

17. An electric vehicle comprising:
a battery pack;
an electric motor electrically connected to the battery pack;
a drive assembly operatively connected to the electric motor;
a handlebar;
a control assembly according to claim 1 connected to the handlebar; and
a controller operatively connected to the electric motor and communicatively connected to the position sensor of the control assembly,
in response to the position sensor sensing that the first actuator is in the brake regeneration mode, the controller controlling the electric motor in a generator mode for decelerating the electric vehicle and for recharging the battery pack; and
in response to the position sensor sensing that the first actuator is in the acceleration mode, the controller controlling the electric motor in a motor mode for driving the drive assembly.
